(19) United States
(12) Patent Application Publication
(10) Pub. No.: US 2024/0076898 A1
(43) Pub. Date: Mar. 7, 2024

(54) SUNSHADE

(71) Applicant: Positec Power Tools (Suzhou) Co., Ltd., Suzhou (CN)

(72) Inventors: Zhenya Xu, Suzhou (CN); Hongkui Lian, Suzhou (CN); Jiang Du, Suzhou (CN)

(21) Appl. No.: 18/243,468

(22) Filed: Sep. 7, 2023

(30) Foreign Application Priority Data
Sep. 7, 2022 (CN) 202222372287.3

(51) Int. Cl. E04H 15/48; B32B 5/02; B32B 5/18; B32B 5/24; B32B 9/02; B32B 9/04; B60L 53/30; E04H 15/02; E04H 15/54

(52) U.S. Cl. CPC E04H 15/48; B32B 5/02; B32B 5/18; B32B 5/245; B32B 9/025; B32B 9/047; B60L 53/30; E04H 15/02; E04H 15/54; B32B 2266/025; B32B 2266/0278; B32B 2307/51; B32B 2307/558; B32B 2307/7376; B32B 2419/00

(57) ABSTRACT

The present disclosure relates to a sunshade configured to park a self-moving device. The sunshade includes a frame and a protective structure arranged outside the frame. The frame is provided with a first opening, a second opening, and a chamber in communication with the first opening and the second opening. The chamber is configured to accommodate the self-moving device. The protective structure is configured for deforming under the action of an external force to form a buffer space.

### BACKGROUND

### Technical Field

The present disclosure relates to the field of electric tools, and in particular to a sunshade.

### Related Art

Common self-moving devices such as lawn mowers are generally placed outdoors for work or parked outdoors. Due to long-term unprotected exposure to the air, devices such as lawn mowers are easily damaged, which may further affect the performance or service life of the devices. Therefore, sunshades are generally built to park self-moving devices such as lawn mowers in a non-working state. Furthermore, devices such as lawn mowers parked in the sunshade can be subjected to the operations of human-computer interaction, maintenance, charging, and the like.

However, in the related art, sunshades are generally built with plastic and metal frameworks as main components. The sunshades may be fixed in places where people are active such as football fields and parks, in this case, people may collide with the sunshade if they do not pay attention while walking or running, which may lead to personal injuries.

### SUMMARY

The present disclosure provides a sunshade with high safety and configured for reducing injuries caused by accidental collision.

The present disclosure provides the following technical solution:: a sunshade configured to park a self-moving device is provided. The sunshade includes:
a frame provided with a first opening, a second opening, and a chamber in communication with the first opening and the second opening, the chamber being configured to accommodate the self-moving device; and
a protective structure arranged outside the frame and deformable under the action of an external force to form a buffer space.

Further, the protective structure includes a first protective layer and a second protective layer, and the buffer space is formed by the first protective layer and the second protective layer.

Further, the buffer space is formed by filling an elastic material between the first protective layer and the second protective layer.

Further, the elastic material is any one of PU sponge, EPE, and XPE.

Further, the first protective layer and the second protective layer include base cloth and a leather layer formed on the base cloth.

Further, a thickness of the protective structure is not less than 40 mm.

Further, along a direction of extension from the first opening to the second opening, a length of the protective structure is not less than a length of the frame.

Further, the frame includes a main bracket and bracket assemblies connected to the main bracket and configured to support the main bracket, and the bracket assemblies are movably connected to the main bracket.

Further, the frame further includes multiple fixed racks, the fixed racks are movably connected to the bracket assemblies, and the frame is fixed on a contact surface through coordination between the fixed racks and fasteners.

Further, the protective structure is detachably arranged on the frame.

The present disclosure has the following beneficial effects: the protective structure is arranged outside the frame of the sunshade provided by the present disclosure, and the protective structure is deformable under the action of an external force to form a buffer space. Therefore, when a person collides with the sunshade, due to the deformation of the protective structure, injuries caused by collision are reduced. In this way, the possibility of personal injuries is reduced, the personal safety is protected, and the safety and aesthetics of the sunshade are also improved.

The above description is only an overview of the technical solution of the present disclosure. In order to more clearly understand the technical means of the present disclosure and implement the technical means in accordance with the contents of the specification, the present disclosure is described in detail below with preferred embodiments of the present disclosure in combination with the accompanying drawings.

### BRIEF DESCRIPTION OF THE DRAWINGS

FIG. 1 is a schematic structural view of a sunshade with a self-moving device parked shown in an embodiment of the present disclosure.

FIG. 2 is a schematic structural view of a frame of the sunshade shown in FIG. 1.

FIG. 3 is another schematic structural view of the frame of the sunshade shown in FIG. 1.

FIG. 4 is another schematic structural view of the sunshade shown in FIG. 1.

### DETAILED DESCRIPTION

The technical solution of the present disclosure is clearly and completely described below with reference to the accompanying drawings. Apparently, the described embodiments are a part of the embodiments of the present disclosure, rather than all of the embodiments. Based on the embodiments in the present disclosure, all other embodiments obtained by those of ordinary skill in the art without creative efforts fall within the protection scope of the present disclosure.

In the description of the present disclosure, it should be noted that the orientations or positional relationships indicated by terms “center”, “upper”, “lower”, “left”, “right”, “vertical”, “horizontal”, “inside”, “outside”, and the like are based on orientations or positional relationships shown in the accompanying drawings. These terms are only for the convenience of describing the present application and simplifying the description, but do not indicate or imply that the specified mechanism or component needs to have a specific orientation and needs to be constructed and operated in the specific orientation, so that the terms cannot be understood as a limitation to the present disclosure. In addition, the terms “first”, “second”, and “third” are used for descriptive purposes only, and cannot be construed as indicating or implying relative importance.

In the description of the present disclosure, it should be noted that unless otherwise clearly specified and defined, the terms “mounting”, “connected to”, and “connection” should be understood in a broad sense. For example, the connection may be fixed connection, detachable connection or integrated connection, or may be mechanical connection or electric connection, or may be direct connection, indirect connection through an intermediate, or internal communication of two components. For those of ordinary skill in the art, the specific meanings of the above terms in the present disclosure can be understood according to specific situations.

In addition, the technical features involved in different embodiments of the present disclosure described below can be combined with each other as long as they do not conflict with each other.

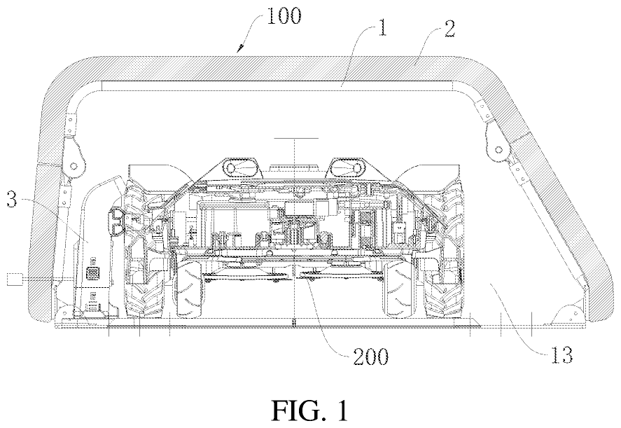

Referring to FIG. 1, a sunshade 100 shown in an embodiment of the present disclosure can be configured to park a self-moving device 200. The self-moving device 200 may be any self-moving device 200 working outdoors, such as a lawn mower, an automatic snow plow, or a multi-functional machine, and will not be enumerated here. When the self-moving device 200 is parked in the sunshade 100, the sunshade 100 can provide shade, rain, snow, or wind protection, and the like, thereby avoiding the self-moving device 200 from being exposed to rain or sunlight, and prolonging the service life of the self-moving device 200.

The sunshade 100 includes a frame 1 and a protective structure 2 arranged outside the frame 1. The frame 1 is configured to support the protective structure 2, and the protective structure 2 plays a shielding role.

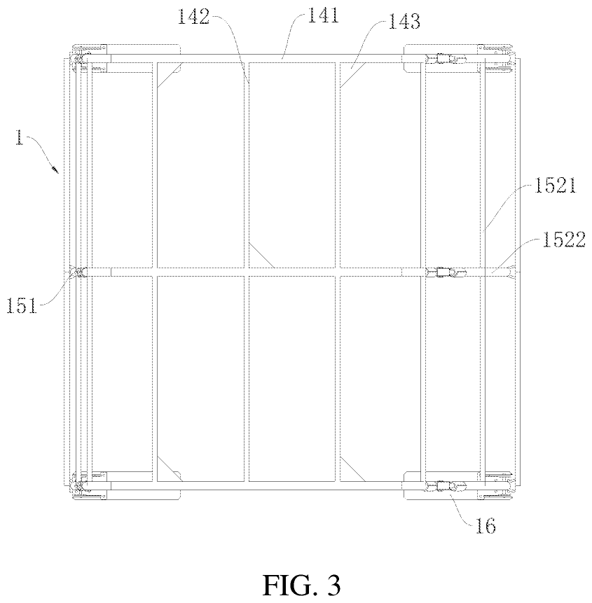

Referring to FIG. 1 to FIG. 3, the frame 1 is provided with a first opening 11, a second opening 12, and a chamber 13 in communication with the first opening 11 and the second opening 12. The chamber 13 is configured to accommodate the self-moving device 200.

The self-moving device 200 can enter the chamber 13 from one of the first opening 11 and the second opening 12 and is parked in the chamber 13. When it is necessary to leave the sunshade 100 for work, the self-moving device can leave the sunshade from an other one of the first opening 11 and the second opening 12. In other embodiments, the self-moving device 200 may also enter or leave only from the first opening 11 or the second opening 12, which is not specifically limited here and can be selected according to actual needs.

The frame 1 plays a supporting role and is generally made of metals such as steel to ensure the firmness and service life of the frame 1, but it is not limited thereto. The frame 1 may also be made of other materials. In other embodiments, in order to prevent the frame 1 made of steel from rusting which affects the service life, strength, and the like of the frame, the outside of the frame 1 may be coated with a protective layer, such as paint.

Specifically, the frame 1 includes a main bracket 14 and bracket assemblies 15 connected to the main bracket 14 and configured to support the main bracket 14. The main bracket 14 includes first transverse rods 141 and first vertical rods 142 connected crosswise. At least two first transverse rods 141 are arranged, and at least two first vertical rods 142 are arranged. The at least two first transverse rods 141 and the at least two first vertical rods 142 are connected crosswise to form a supporting structure. The at least two first transverse rods 141 are arranged spaced away, and the at least two first vertical rods 142 are also arranged spaced away.

In this embodiment, three first transverse rods 141 are arranged, and the first transverse rod 141 is a 16 mm steel tube. Five first vertical rods 142 are arranged, and the first vertical rod 142 is a 10 mm steel bar. The number of the first transverse rod 141 and the number of the first vertical rod 142 are not specifically limited here, and the size of the first transverse rod and the size of the first vertical rod are also set according to the strength of actual needs.

The first vertical rod 142 and the first transverse rod 141 can be connected by welding or other processes to improve the connection stability between the first vertical rod and the first transverse rod.

In this embodiment, a reinforced piece 143 is arranged between the first transverse rod 141 and the first vertical rod 142 to further improve the firmness between the first transverse rod 141 and the first vertical rod 142.

The bracket assembly 15 includes a first bracket 151 and a second bracket 152. The first bracket 151 and the second bracket 152 are oppositely arranged at two ends of the main bracket 14, and the first bracket 151 and the second bracket 152 are respectively connected to two ends of the main bracket 14 to support the main bracket 14.

The structure of the first bracket 151 is the same as the structure of the second bracket 152. Here, the second bracket 152 is taken as an example for detailed description. The second bracket 152 includes a second vertical rod 1521 and a second transverse rod 1522. The number of the second transverse rod 1522 is completely the same as the number of the first transverse rod 141 of the main bracket 14, and the second transverse rod 1522 is connected to the first transverse rod 141 in a one-to-one correspondence. The second transverse rod 1522 is also a 6 mm steel tube.

At least one second vertical rod 1521 is arranged, and the second vertical rod 1521 and the first vertical rod 142 are roughly parallel. In this embodiment, two second vertical rods 1521 are arranged. Similarly, the number of the second vertical rod 1521 can be set according to actual needs. The second vertical rod 1521 is a 10 mm steel bar. The second vertical rod 1521 and the second transverse rod 1522 can also be connected by welding or other processes to improve the connection stability between the second vertical rod and the second transverse rod.

The frame 1 can be abutted and fixed to a contact surface, and the contact surface may be a position on the ground or lawn where the sunshade 100 needs to be mounted. When the sunshade 100 needs to be mounted on the contact surface, one end of each of the first bracket 151 and the second bracket 152 away from the main bracket 14 is abutted to the contact surface.

In order to increase the stability of the bracket assembly 15 abutted to the contact surface and avoid the frame 1 from easily tipping under the action of a wind force or an external force, the frame 1 further includes multiple fixed racks 16 connected to the bracket assembly 15. The contact area between the frame 1 and the contact surface is increased through the fixed racks 16.

The frame 1 is fixed on the contact surface through coordination between the fixed racks 16 and fasteners to further increase the stability between the frame 1 and the contact surface. The fastener may be a screw, or the like. Correspondingly, the fixed rack 16 is provided with a threaded hole 161 in threaded fit with the fastener. Multiple threaded holes 161 may be provided. In this embodiment, the fixed rack 16 is provided with three threaded holes 161. However, other numbers of threaded holes 161 may also be provided, which is not specifically limited here.

In this embodiment, four fixed racks 16 are arranged, and the four fixed racks 16 are respectively connected to two ends of the first bracket 151 and the second bracket 152 to increase the stability of the frame 1 on the contact surface. In other embodiments, five or six fixed racks 16 may also be provided, and the number of the fixed rack is not limited here.

The fixed rack 16 is located in the chamber 13 to reduce the space of the frame 1 mounted on the contact surface. In other embodiments, the fixed rack 16 may also be located outside the chamber 13. In this embodiment, the fixed rack 16 is a steel sheet with a width of 5 mm to ensure the contact area between the frame 1 and the contact surface.

The first transverse rod 141 has a similar “concave” structure. When the frame 1 is mounted on the contact surface, the first opening 11 and the second opening 12 have a similar trapezoidal structure, and a length of the side close to the contact surface is greater than a length of the side away from the contact surface, so that the self-moving device 200 can more conveniently enter the chamber 13 from the first opening 11 or the second opening 12.

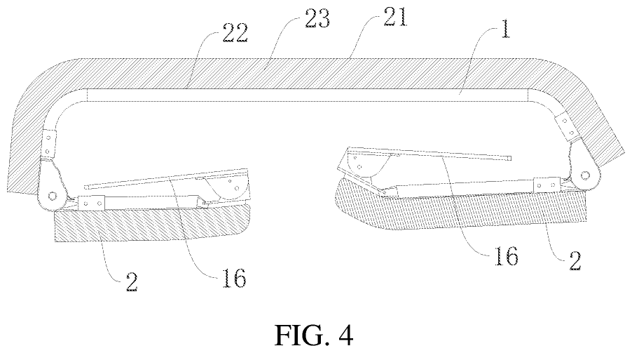

Referring to FIG. 4, the bracket assembly 15 is movably connected to the main bracket 14. In this embodiment, the first bracket 151 and the second bracket 152 are rotationally connected to the main bracket 14 respectively through hinges, thereby facilitating the folding of the bracket assembly 15 relative to the main bracket 14, and facilitating the storage and movement of the frame 1. Furthermore, the fixed rack 16 is movably connected to the bracket assembly 15, and the fixed rack 16 can also be folded relative to the bracket assembly 15, thereby further facilitating the storage and movement of the frame 1.

The fixed rack 16 and the bracket assembly 15 can be connected through structures such as folding hinges. The bracket assembly 15 and the main bracket 14 as well as the fixed rack 16 and the bracket assembly 15 may also be connected in other manners, such as a pivoting manner, and the connection manner is not specifically limited here.

When the protective structure 2 is arranged on the frame 1, the protective structure is specifically arranged on the main bracket 14 and the bracket assembly 15 and does not block the first opening 11 and the second opening 12, so as to ensure that the self-moving device 200 enters and leaves the chamber 13 from the first opening 11 or the second opening 12.

The protective structure 2 is detachably arranged on the frame 1 to facilitate the replacement and maintenance of the protective structure 2. Specifically, the protective structure 2 is fixed on the frame 1 through magic tapes, screws, and the like, or may be directly sleeved over the frame 1. In other embodiments, the protective structure 2 may also be fixed on the frame 1 in a gluing manner.

The sunshade 100 may be fixed in places where people are active such as football fields and parks, in this case, people may collide with the sunshade 100 if they do not pay attention while walking or running, which may lead to personal injuries. The protective structure 2 plays a shielding role, and the protective structure 2 is deformable under the action of an external force to form a buffer space. Therefore, when a person collides with the sunshade 100, due to the deformation of the protective structure 2, injuries caused by collision are reduced. In this way, the possibility of personal injuries is reduced, and the personal safety is protected.

Referring to FIG. 1 and FIG. 4, the protective structure 2 includes a first protective layer 21 and a second protective layer 22, and the buffer space is formed by the first protective layer 21 and the second protective layer 22.

In this embodiment, the buffer space is formed by filling an elastic material between the first protective layer 21 and the second protective layer 22. The elastic material filled between the first protective layer 21 and the second protective layer 22 is referred to as an elastic layer 23. The elastic layer 23 is deformable under the action of an external force to protect the personal safety. In other embodiments, the first protective layer 21 and the second protective layer 22 can be connected to form a buffer space.

In this embodiment, the elastic layer 23 is made of an elastic material, forms a buffer space under the action of an external force, and also prevents the direct contact between a person and a bracket of a metal material, thereby further avoiding injuries of the person due to collision with the sunshade 100. It should be noted that the first protective layer 21 and the second protective layer 22 are also made of flexible materials which can protect the personal safety and can also avoid the influence of the first protective layer 21 and the second protective layer 22 on the formation of the buffer space by the elastic layer 23 under the action of an external force.

The elastic material is any one of PU sponge, EPE, and XPE, but is not limited thereto. The elastic material may also be other elastic materials which are not enumerated here. The EPE is waterproof, dampproof, shockproof, soundproof, and heat-insulating, and has strong plasticity and toughness and low cost. The XPE has good heat insulation and strong sound absorption properties, and compared with the EPE, the XPE has higher tensile strength and is pollution-free after being burned, but has relatively high cost. The material of the elastic layer 23 can be selected according to actual needs.

A thickness of the elastic layer 23 is not less than 40 mm to ensure the buffer effect of the elastic layer 23, prevent the personnel from being injured, and reduce the possibility and degree of injuries.

The first protective layer 21 and the second protective layer 22 include base cloth and a leather layer formed on the base cloth. The first protective layer 21 and the second protective layer 22 have a same structure or different structures. For the convenience of production, in this embodiment, the first protective layer 21 and the second protective layer 22 have a same structure.

The base cloth is any one of gauze, Oxford cloth, and acupuncture cotton. The leather layer is PU leather or PVC leather. The base cloth and the leather layer may also be made of other materials, which are not specifically limited here. The gauze has poor tensile strength, but has low cost. The Oxford cloth has light texture, good waterproofness, good durability, and high tensile strength, but has relatively high cost. The acupuncture cotton has soft feel, high density, good air permeability, and high tensile strength, but has high cost. The PU leather has poor waterproofness, good wear resistance, strong leather feel, soft texture, bright colors, and moderate price, but has relatively short service life. The PVC leather is resistant to decomposition and corrosion, textures can be customized, and the service life can reach five years. Compared with the PVC leather, the PU leather has lower toxicity, is more environment-friendly, and has softer hand feel. Compared with the PU leather, the PVC leather is durable, tear-resistant, scratch-resistant, and flame-resistant, and has better weather resistance. The selection of the base cloth and the leather layer can be set according to actual needs.

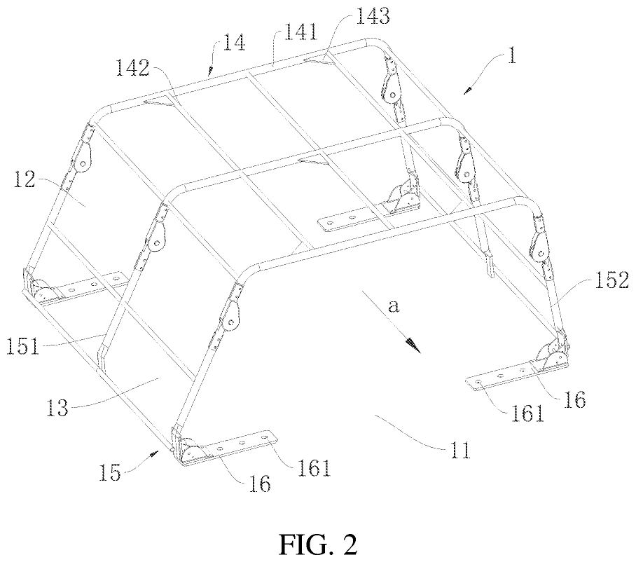

Along a direction of extension from the first opening 11 to the second opening 12, a length of the protective structure 2 is not less than a length of the frame 1. A direction of extension from the first opening 11 to the second opening 12 is shown by an arrow a in FIG. 2.

Along the direction a, the length of the protective structure 2 is not less than the length of the frame 1 to ensure that the protective structure 2 completely covers the frame 1, thereby avoiding direct contact between a person and the frame 1 from the first opening 11 or the second opening 12. In a preferred embodiment, the length of the protective structure 2 is greater than the length of the frame 1, that is, two ends of the protective structure 2 extend out of the frame 1, thereby further avoiding the exposure of the frame 1, further improving the safety performance of the sunshade 100, and avoiding personal injury.

It should be noted that the leather layer is arranged at the outermost layer of the protective structure 2 to play a waterproof role and the like to prolong the service life of the protective structure 2. Moreover, the color of the leather layer can be changed to improve the aesthetics of the sunshade 100.

In this embodiment, in order to avoid leakage of the elastic layer 23 between the first protective layer 21 and the second protective layer 22, an accommodating cavity can be enclosed between the first protective layer 21 and the second protective layer 22, and the elastic layer 23 is located in the accommodating cavity.

In addition, as mentioned above, the protective structure 2 is arranged on the main bracket 14 and the bracket assembly 15, and the frame 1 has a foldable structure. In order to facilitate the folding of the frame 1, the protective structure 2 is divided into three parts, where one part is arranged on the main bracket 14, and the other two parts are respectively arranged on the first bracket 151 and the second bracket 152.

In other embodiments, the protective structure may also deform under the action of an external force to form a structure of a buffer space. For example, the protective structure can protect an elastic component arranged on the outside of the frame, and a plate connected to the elastic component. When the plate is subjected to an external force, the elastic component deforms and causes the plate to move towards a direction of the frame to form a buffer space. The specific structure of the protective structure is not specifically limited here.

Referring to FIG. 1, a charging station 3 may further be arranged in the sunshade 100. The self-moving device 200 can be parked in the sunshade 100 and charged to ensure that the self-moving device 200 has sufficient power to work. The sunshade 100 provides shade and rain protection, and also can directly charge the self-moving device 200. There is no need to use an additional longer power cord to obtain power from a household AC power source, thereby facilitating the operation.

The charging station 3 may include a circuit assembly and an interface connected to the circuit assembly. The circuit assembly can be connected to a storage battery or external mains to realize power supply. Through the interface, a charging base of the self-moving device 200 can be connected to charge the self-moving device 200.

The circuit assembly further includes a voltage transformation circuit. The voltage transformation circuit is configured to adjust the output voltage of the interface, and power can be supplied to any AC-powered device that requires AC power supply through the interface. Parameters of the voltage transformation circuit are adjusted according to different voltages required by AC-powered devices, so that the interface can output matched voltages. Therefore, the sunshade 100 can be applicable to any AC-powered devices.

The sunshade 100 may further include a sealed box. The circuit assembly is arranged in the sealed box to avoid circuit faults caused by the contact between the circuit assembly and outdoor dust or moisture, so as to play a protective role, thereby prolonging the service life of the charging station 3.

In conclusion, the outside of the frame of the sunshade provided by the present disclosure is provided with a protective structure, and the protective structure is deformable under the action of an external force to form a buffer space. Therefore, when a person collides with the sunshade, due to the deformation of the protective structure, injuries caused by collision are reduced. In this way, the possibility of personal injuries is reduced, the personal safety is protected, and the safety and aesthetics of the sunshade are also improved.

The technical features of the above embodiments can be combined arbitrarily. For concise description, not all possible combinations of the technical features in the above embodiments are described. However, as long as there is no contradiction in the combinations of these technical features, they should be considered within the scope of this specification.

The above embodiments only express several embodiments of the disclosure, and the descriptions are relatively specific and detailed, but cannot be understood as a limitation on the scope of the disclosure. It should be noted that those of ordinary skill in the art can also make several modifications and improvements without departing from the concept of the disclosure, and these modifications and improvements all fall within the protection scope of the disclosure. Therefore, the protection scope of the disclosure should be subject to the appended claims.

1-10. (canceled)

11. A sunshade configured to park a self-moving device, comprising:
a frame provided with a first opening and a chamber that in communication with the first opening, the chamber being configured to accommodate the self-moving device; and
a protective structure arranged outside the frame and deformable under the action of an external force to form a buffer space and prevent direct contact between a force provider and the frame.

12. The sunshade according to claim 11, wherein the protective structure comprises a first protective layer and a second protective layer, and the buffer space is formed by the first protective layer and the second protective layer.

13. The sunshade according to claim 12, wherein the buffer space is formed by filling an elastic material between the first protective layer and the second protective layer.

14. The sunshade according to claim 13, wherein the elastic material is any one of PU sponge, EPE, and XPE.

15. The sunshade according to claim 12, wherein the first protective layer and the second protective layer comprise base cloth and a leather layer formed on the base cloth.

16. The sunshade according to claim 11, wherein a thickness of the protective structure is not less than 40 mm.

17. The sunshade according to claim 11, wherein the frame comprises a main bracket and bracket assemblies connected to the main bracket and configured to support the main bracket, and the bracket assemblies are movably connected to the main bracket.

18. The sunshade according to claim 17, wherein the frame further comprises a plurality of fixed racks, the fixed racks are movably connected to the bracket assemblies, and the frame is fixed on a contact surface through coordination between the fixed racks and fasteners.

19. The sunshade according to claim 11, wherein the protective structure is detachably arranged on the frame.

20. The sunshade according to claim 11, wherein the protective structure does not block the first opening.

21. The sunshade according to claim 20, wherein the self-moving device enters and/or leaves the chamber from the first opening.

22. The sunshade according to claim 11, wherein the frame at least comprises a main bracket and bracket assemblies, the main bracket is arranged at a top of the frame, and the bracket assemblies are arranged on two sides of the frame in a direction perpendicular to a direction of the first opening extending towards the chamber; and
the protective structure is arranged on the main bracket and the bracket assemblies.

23. The sunshade according to claim 11, wherein the frame further comprises a second opening, the second opening is arranged at another end of the frame away from the first opening, and the protective structure does not block the second opening.

24. The sunshade according to claim 23, wherein the self-moving device enters and/or leaves the chamber from at least one of the first opening and the second opening.

25. The sunshade according to claim 23, wherein along a direction of extension from the first opening to the second opening, a length of the protective structure is equal to or greater than a length of the frame.

26. The sunshade according to claim 11, wherein a charging station is arranged in the chamber.
